(19) United States
(12) Patent Application Publication
(10) Pub. No.: US 2014/0166396 A1
(43) Pub. Date: Jun. 19, 2014

(54) Conduits and methods for use with marine evacuation systems

(71) Applicants: Paul Ceeney, Katy, TX (US); Gary Ceeney, Fulshear, TX (US)

(72) Inventors: Paul Ceeney, Katy, TX (US); Gary Ceeney, Fulshear, TX (US)

(21) Appl. No.: 13/694,758

(22) Filed: Jan. 2, 2013

Related U.S. Application Data
(63) Continuation-in-part of application No. 13/694,620, filed on Dec. 17, 2012.
Application No. 13/694,620 is a continuation-in-part of application No. 13/694,618, filed on Dec. 17, 2012.

(51) Int. Cl. A62B 1/20

(52) U.S. Cl. CPC A62B 1/20
USPC 182/48

(57) ABSTRACT

Conduits and methods for use evacuating a facility include a first end positioned at the facility, a second end movable between the facility and a remote location, at least one elongate member engaged with the body of the conduit and the facility, and at least one stabilization member engaged with the elongate member(s). Angled panels within the interior, oriented in opposition to adjacent panels, can permit users to transit through the body at a controllable rate. The material of the conduit or an outer sheath can protect users from flame, smoke, gas, or other hazards. The second end can engage a breakaway platform removably engaged with an escape vessel, enabling individuals to transit directly from a facility to the vessel. The elongate member(s) can pass through orifices in the platform to enable relative vertical motion between the platform/vessel and elongate member(s).

### CROSS-REFERENCE TO RELATED APPLICATIONS

This application is a continuation-in-part application claiming the benefit of the co-pending United States patent application having the application Ser. No. 13/694,620, filed Dec. 17, 2012, entitled “Marine Evacuation Systems and Methods,” and the benefit of the co-pending United States patent application having the application Ser. No. 13/694,618, filed Dec. 17, 2012, entitled “Escape Vessel with Detachable Landing,” each of which are incorporated by reference herein, in their entirety.

### FIELD

Embodiments usable within the scope of the present disclosure relate, generally, to marine evacuation systems usable to launch escape vessels from facilities, such as fixed or mobile offshore oil and gas facilities, and more specifically, to conduits and methods for accessing escape vessels from facilities while protecting users thereof from emergent conditions, such as heat, explosion, fire, or capsizing of the facility.

### BACKGROUND

Evacuation during an emergent situation from an offshore vessel or facility, such as an oil and gas platform, is primarily accomplished using davit or freefall lifeboats, which are mandated by international (e.g., IMO SOLAS) and various national laws. To enable evacuation of personnel that are unable to access the lifeboats in an emergent situation (e.g., fire, explosion, etc.), an alternative “secondary” means of evacuation is also typically provided, which can include throw-over, self-righting life rafts, mounted at all deck levels around a facility. Other alternative means can include evacuation systems having an open-mesh stocking and/or chute connecting a deck of a facility to an open-boarding raft located at sea level, the open-boarding raft having multiple life rafts connected thereto. Use of an open-mesh stocking is preferred to minimize wind resistance and the potential for wind to displace a deployed chute; however, personnel descending through an open-mesh stocking are unprotected from smoke, direct flame envelopment, and high heat flux, which are common emergent situations that require evacuation. Such hazards associated, for example, with an offshore oil and gas facility, can include a fire with accompanying dense toxic and/or asphyxiating combustion products, explosion followed by fire and smoke, major gas release, or combinations thereof It is also common for personnel to become caught and/or injured in the open-mesh material. Incapacitation of an evacuee within an escape chute by these or other hazards can prevent further evacuation by blocking the chute. Further, if an emergency causes a vessel or facility to capsize or otherwise reach a non-vertical orientation, the possibility exists for evacuees to become trapped in the chute.

Once an individual reaches an open boarding raft, other potential dangers exist, due to the fact that an open boarding raft provides no protection from waves or weather, which creates the potential for individuals to be washed overboard, slip and fall into the sea, or fall between the boarding raft and life raft during the cross-boarding process. Additionally, each of the separate life rafts must be pulled into an open boarding raft and tied off, which is a hazardous undertaking, especially during moderate to severe weather conditions. Also, by evacuating personnel into multiple life rafts the personnel are dispersed and therefore more difficult to recover following and emergent situation.

A need exists for conduits and methods that protect personnel from emergent conditions, such as flames, heat, and smoke, during an evacuation process, and also reduce the potential for entanglement and/or injury while traversing a conduit.

A need also exists for conduits and methods that reduce or eliminate the possibility of an individual becoming trapped while traversing a conduit.

A further need exists for conduits that are both deployable and boardable, from the deck of a facility, and that transit directly to an escape vessel, without requiring cross-boarding or similar hazardous undertakings.

Embodiments usable within the scope of the present disclosure meet these needs.

### SUMMARY

Embodiments usable within the scope of the present disclosure relate to conduits (e.g., vertical telescoping escape chutes) usable with offshore marine evacuation systems. An embodiment includes a chute body formed from a close-knit material, such as Kevlar Raschel Warp Knit (e.g., composed 100% from Kevlar29, available from DuPont, which is a 1000 denier material). The body of the conduit can be formed into a tubular (e.g., cylindrical) shape, such as through use of Kevlar thread, marine-grade polyvinylchloride, or similar materials. In an embodiment, the conduit can be modular and/or extendable, through attachment of multiple sections (e.g., 48-inch tubular sections, attachable end-to-end). Between adjacent sections, the conduit can include a connecting member, such as a stainless steel hoop (e.g., a 42-inch diameter hoop). The chute body can be supported using ropes, cables, or similar elongate members, which in an embodiment, can include 4600 lb-rated Kevlar ropes, with turned and spliced looped ends connected to each hoop or similar connector between sections of conduit, through use of appropriate connectors and/or fasteners (e.g., 5000 lb-rated 316-grade stainless steel shackles).

Integration of ropes and/or cables directly into the chute body provides the conduit with a high degree of vertical load bearing capacity, which enables a stable chute having longer lengths than what is conventionally possible, and enabling a larger number of personnel to traverse the conduit at one time. Use of Kevlar or similar close-knit and/or heat resistant materials can provide a barrier to protect personnel from heat flux and other extreme temperatures. In an embodiment, at least a portion of the conduit (e.g., the upper portion thereof that would be exposed to emergent conditions from a facility) can include an outer and/or inner sheath that protects personnel from fire, gas, smoke, and/or other similar hazards. In an embodiment, a portion of the conduit (e.g., the sheath and/or the upper portion thereof) can include a light source, such as a ribbon light rated for use in a flammable environment (Zone I, Div I, Class I), to illuminate the conduit. Such a light source can be powered using a contained battery and/or a power source available from the facility.

In an embodiment, the interior of the conduit can be provided with slide sections, which can be oriented such that adjacent sections of the conduit include slides having opposing angles relative to each adjacent section, such that users traversing the conduit move in a “zig-zag” motion, enabling users to transit through the conduit in a controlled manner (e.g., through one section/cell at a time). In a further embodiment, at least one, and potentially, all sections of the conduit can be provided with a discrete escape panel, such that if the conduit becomes blocked, a user becomes stuck, and/or the facility capsizes or otherwise orients in a non-vertical direction, personnel will be able to exit the chute independent of their location within.

As such, embodiments usable within the scope of the present disclosure can reduce the exposure of personnel to heat, smoke, gas, and flames, while reducing the potential for becoming caught and/or trapped, both due to the use of a close-knit material and the placement of escape panels.

The conduit can include a telescoping chute, able to be stored within a container and/or frame positioned at a facility, and deployed from the level of the facility deck to the level of a body of water below. In an embodiment, an end of the chute can be engaged with a platform removably attached to an escape vessel (e.g., an inflatable life raft), such that personnel that transit through the conduit can move directly from the facility deck to the escape vessel, without requiring use of an open-boarding raft or similar hazardous undertakings. After boarding, the platform can be detached from the life raft, such as through disengagement of quick disconnect pins and/or clamps, enabling the raft to float free of the escape chute and away from a hazard. The escape chute and/or platform can then be recovered for reuse, such as through use of a winch or similar mechanism.

### BRIEF DESCRIPTION OF DRAWINGS

The accompanying drawings, which are incorporated in and constitute a part of this specification, illustrate an implementation of apparatus consistent with the present invention and, together with the detailed description, serve to explain advantages and principles consistent with the invention.

FIG. 1 depicts a diagrammatic isometric view of an embodiment of a conduit usable within the scope of the present disclosure, with the outer surface removed to enable visualization of internal components.

FIG. 2 depicts a diagrammatic side view of the conduit of FIG. 1.

FIG. 3 depicts a diagrammatic side view of an embodiment of a marine evacuation system usable within the scope of the present disclosure, with an escape conduit shown in a deployed position.

FIG. 4A depicts a diagrammatic side view of the marine evacuation system of FIG. 3, with an escape conduit shown in a retracted/stored position.

FIG. 4B depicts a diagrammatic top view of the marine evacuation system of FIG. 4A.

### DESCRIPTION OF EMBODIMENTS

Embodiments usable within the scope of the present disclosure relate to conduits (e.g., escape chutes) and methods usable with evacuation systems. A specific embodiment can include a telescoping chute, formed from close-knit Kevlar or a similar durable, close-knit material, that can be stored, e.g., in a container, skid, and/or frame in a folded/retracted position, that can be extended from the deck of a facility (e.g., an oil and gas platform, a vessel, etc.) to a body of water below. For example, a pneumatic winch and associated cables, pulleys, accumulators, drum, and structural supports can be used to raise/lower the conduit, though other mechanisms can be used without departing from the scope of the present disclosure. The end of the conduit remote from the facility can be engaged to a platform, the platform having an escape vessel (e.g., an inflatable life raft) engaged thereto, such that after deployment of the conduit, personnel can transit through the conduit from the facility directly to the escape vessel. The escape vessel can be detached from the platform to enable movement of the vessel away from the facility and/or any associated hazards. A stabilization system (e.g., cable tensioning cans) can also be provided in association with the conduit and deployed concurrently with the remainder of the system.

Embodiments of the conduit can include modular sections, attachable (e.g., end-to-end), with connectors (e.g., stainless steel hoops) therebetween, while stabilization cables (e.g., high tensile strength Kevlar cables) can connect each section of the conduit to provide strength thereto. The cables can further be connected to the stabilization system, such that the weight of the stabilizing members (e.g., tensioning cans) of the stabilization system maintain the cables and conduit in a generally vertical orientation. Internal slide panels can be arranged in an opposing, e.g., “zig-zag” pattern along which personnel can transit, while one or multiple sections of the conduit can include escape panels for enabling personnel to exit the conduit when downward transit through the interior of the conduit and/or along the slide is not possible or becomes undesirable.

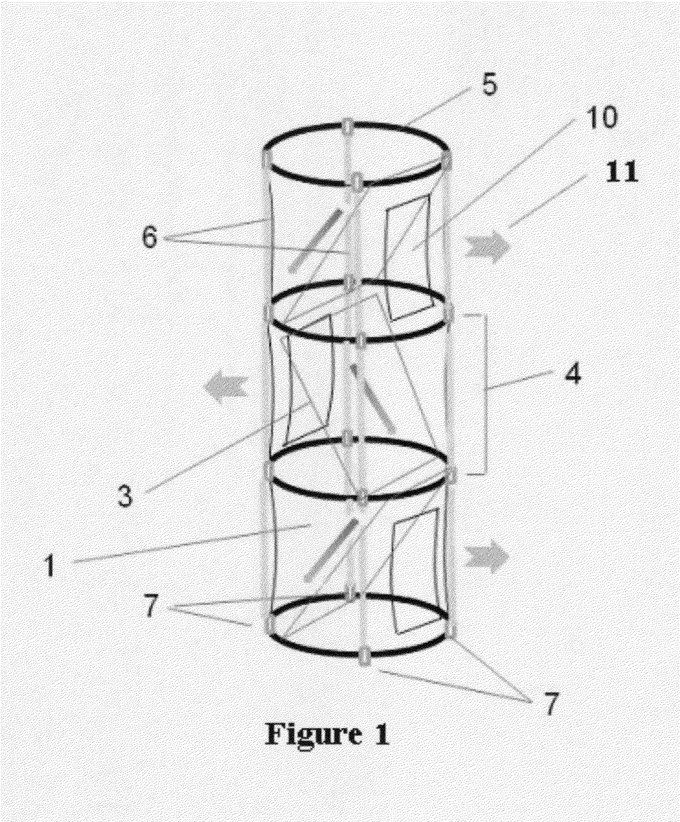

With reference to FIG. 1, an embodiment of a conduit (1) is shown, which can be formed from a close-knit material, such as a Kvelar Raschel Warp Knit (e.g., composed of 100% Kevlar29, available from DuPont), or a similar close-knit, durable material (e.g., 1000 denier). The conduit (1) has been provided with a generally cylindrical and/or tubular shape, and in an embodiment, can be formed into such a shape through use of Kevlar thread and marine grade polyvinylchloride, or other durable materials. It should be understood, however, that while the figures depict a generally cylindrical conduit (1), other embodiments can include conduits having other shapes (e.g., square tubular, rectangular, spiraled, etc.) without departing from the scope of the present disclosure. Additionally, it should be understood that the conduit (1) shown in FIG. 1 is only an exemplary portion of a usable conduit (e.g., FIG. 1 depicts a portion of a conduit that is about 12 feet in length, having a diameter of about 42 inches), and that usable conduits could have any length and/or dimensions, as desired. For example, FIG. 1 depicts the conduit (1) having three discrete sections of which an exemplary section (4) is labeled for reference. Additional sections could be added to the depicted conduit (1), and/or sections could be removed, depending on the overall desired length thereof. In an embodiment, the conduit (1) can be formed from modular sections approximately 48 inches in length. Alternatively, a conduit of any desired length could be integrally formed as a single piece, or any number of separate sections.

Between each adjacent section (4), a connector (5) is shown, the depicted connectors including a ring or hoop-shaped structure having a diameter generally equal to that of the conduit (1). In an embodiment, the connectors (5) can include stainless steel hoops, e.g., 316-grade stainless steel, having a width of about 0.75 inches, and a diameter of about 42 inches. Stabilization cables (6) are shown positioned along the sides of the conduit (1), supporting each section (4) thereof and engaging each connector (5) at a shackle (7) or similar type of eye or connector. In an embodiment, the cables (6) can include 4600 lb rated Kevlar ropes, with turned and spliced looped ends connected to each connector (5); however, any generally elongate member can be used to provide stability to the conduit (1) without departing from the scope of the present disclosure. While FIG. 1 depicts four cables (6), generally equidistantly spaced about the circumference of the conduit (1), any number of cables having any configuration can be used, e.g., depending on the dimensions and/or material characteristics of the conduit (1) and cables (6). Integration of the cables (6) directly into the conduit (1) provides the conduit (1) with a high degree of vertical load bearing capacity, enabling conduits of greater lengths than what is conventionally possible to be stably constructed, and also enabling a larger number of personnel to traverse the conduit (1) at one time.

Within each section (4), e.g., between each connector (5), a slide panel (3) is shown connected (e.g., stitched) in the interior of the conduit (1). Each slide panel (3) is shown arranged in an opposing position relative to each adjacent slide panel (3), such that the slide panels (3) define a “zig-zag” shape along which personnel can traverse. Each section (4) is also shown including an escape panel (10) formed in a side thereof, such that individuals can exit the conduit (1) (e.g., in the direction indicated by arrows (11)) should the conduit (1) become blocked or should further downward transit become impossible or otherwise undesirable.

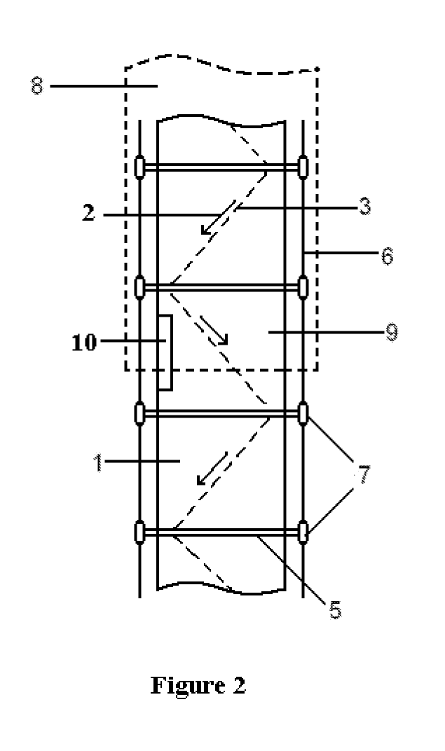

With reference to FIG. 2, a diagrammatic side view of the conduit (1) is shown, formed from discrete sections (e.g., 48 inch cylindrical sections) of a close-knit (e.g., Kevlar) material, attached (e.g., end-to-end) at ring or hoop-type connectors (5), with stabilization cables (6) extending along the sides thereof, that engage eyes and/or shackles (7) extending from and/or otherwise engaged with the connectors (5). The slide panels (3) are shown through the material of the conduit (1) using dashed lines, each panel (3) being positioned such that personnel can transit through the conduit (1) in a “zig-zag” motion, as indicated by the arrows (2). While the close-knit (e.g., Kevlar) material of the conduit (1) can protect personnel from heat flux, the depicted embodiment includes an outer sheath (8) positioned over an upper portion of the conduit 91), the sheath (8) being adapted to prevent the passage of fire, gas, and/or smoke, thereby protecting personnel within the conduit (1) from these hazards. The sheath (8) and/or one or more portions of the conduit (1) can be fitted with a light source (9) (e.g., an internal ribbon light) for illuminating the conduit, such as during periods of limited visibility (e.g. night hours, inclement weather, smoke, etc.). The light source (9) can be rated for use in a flammable environment (e.g., Zone I, Div I, Class I), and can be adapted to illuminate as the conduit (1) is deployed, such as through use of a digital position switch. In an embodiment the light source (9) can be powered by a 24 vdc Exd, Exe, or Intrinsically safe power unit located within or proximate to the conduit (1) (e.g., a container within which the conduit (1) is stored when retracted), and can further include a battery or similar independent power source such that no external power is required to illuminate the light source (9). While FIG. 2 shows the sheath (8) having a length that covers an upper portion of the conduit (1), it should be understood that the length of the sheath (8) can vary depending on the distance from the deck of a facility to an escape vessel or other remote location. Typically, the potential for exposure of personnel to hazards such as flames, smoke, heat, and the like diminishes once an evacuee transits a short distance below the level of a facility deck; however, in various embodiments, the conduit (1) can include a protective sheath that covers its entirety, lower portions thereof, upper portions thereof, central portions thereof, or any combination.

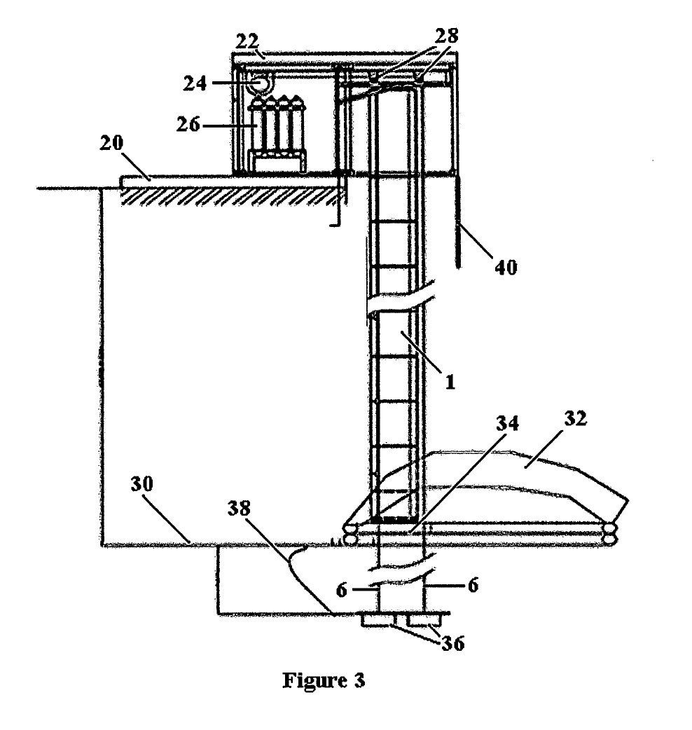

Referring now to FIG. 3, an embodiment of a marine evacuation system, usable with the conduit (1) shown in FIGS. 1 and 2 and/or other similar conduits, is depicted. The system is shown within a container and/or skid frame (22) positioned on the deck (20) of a facility, such that a forward portion/compartment of the container and/or skid frame (22) extends outward from the deck (20) (e.g., overhanging therefrom) above a body of water (30). The container and/or skid frame can be bolted to the deck (20) and/or any intermediate support structure. In an embodiment a skid frame can be attached to and/or otherwise provided into association with the deck (20) and a container housing the evacuation system can be bolted to and/or otherwise secured to the skid frame. The container and/or skid frame (22) can be designed to protect the contents and any personnel within from smoke, fire, heat, and/or explosion.

The rear portion of the container and/or skid frame (22) is shown having a pneumatic winch (24) contained therein, with associated accumulator bottles (26) and pulleys (28), usable to deploy and retract the stabilization cables and/or wires (6), such that the winch (24) is usable to deploy the conduit (1) from the level of the deck (20) to the level of the body of water (30) below. An embodiment can include one or more light sources within the container and/or skid frame (22) (e.g., explosion-proof fluorescent light units), with an associated electrical junction box and/or similar power source (e.g., external connections form the facility or self-contained sources of power.) While the depicted embodiment includes a pneumatic winch (24), it should be understood that any mechanical, electrical, hydraulic, or other comparable mechanism can be used to deploy and/or retract the conduit (1) and/or other portions of the system.

FIG. 3 depicts the system in a deployed position, with the conduit (1) extending from the level of the deck (20), through an opening in the skid frame and/or container (22) (having a trap door (40) in association therewith), to that of the body of water (30), terminating at a breakaway landing platform (34) engaged with a high capacity life raft (32) (e.g., using one or more pins, clamps, etc. adapted for quick removal/disconnection). The stabilization cables (6) can extend through orifices in the platform (34) to engage stabilization members (36), shown as tension cans, beneath the surface of the water (30). The stabilization members (36) are thereby usable to stabilize the conduit (1), while vertical movement of the platform (34) and/or raft (32), such as motion caused by waves, is permitted due to the relative movement permitted between the platform (34) and cables (6). A painter line (38) of the raft (32) is shown attached to one of the stabilization members (36), such that deployment of the stabilization members (36) can cause inflation of the raft (32) during and/or after extension of the conduit (1).

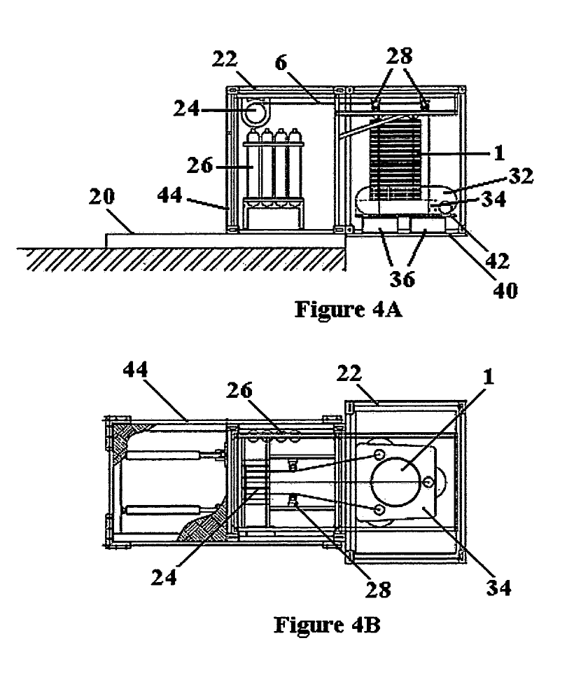

FIGS. 4A and 4B depict side and top views, respectively, of the system of FIG. 3 in a stowed position, in which the conduit (1), raft (32), and platform (34) are retracted into the container and/or skid frame (22) for storage and protection thereof. The raft (32) is shown folded and/or otherwise positioned around the retracted/stowed conduit (1) and supported by a grating (42). The conduit (1) can be anchored at its upper end to the container and/or skid frame (22) and/or an intermediate support structure/frame, and at its lower end to the platform (34). The stabilization members (36) are shown underneath the grating (42), the grating (42) being deployable therewith and/or retainable with the raft (32). FIG. 4A also depicts the trap door (40) in a closed position for retaining the conduit (1), raft, (32), platform (34), grating (42) and/or stabilization members (36) therein. The container and/or skid frame (22) is also shown having a door and/or panel (44) that is openable to permit access between the container (22) and the facility. FIG. 4A depicts the panel (44) in a closed position, while FIG. 4B depicts the panel in an open position.

In use, the winch (24) can be used, e.g., in conjunction with the accumulators (26), to lower the platform (34) and raft (32) to the body of water (30) while extending the conduit (1) to the position shown in FIG. 3. Continued operation of the winch can lower the stabilization members (36) and grating (42) beneath the water (30), providing stability to the conduit (1) while actuating the painter line (38, shown in FIG. 3) to inflate the raft (32). Use of a pneumatic winch enables operation thereof without requiring external power, though it should be understood that other mechanisms could also be used to deploy the system without departing from the scope of the present disclosure. FIG. 4B shows three stabilization cables and/or wires (6) extending from the winch (24) and passing through corresponding orifices formed within the landing platform (34).

The stabilization cables (6) thereby provide stability to the conduit (1), both due to their association and/or engagement with portions of the conduit (1), and through their engagement with the stabilization members (36), while allowing vertical movement of the platform (34) and/or raft (32) due to the ability of the cables (6) to move freely within orifices in the platform (34). In an embodiment, relative horizontal and/or rotational movement between the raft (32) and platform (34) can be permitted, such as through use of a platform having a first portion (e.g., an interior portion, such as a ring or hoop) engaged with the conduit (1), and a second portion (e.g., an exterior ring, hoop, or similar portion) engaged to the raft (32) and/or any intermediate connectors (e.g., webbing straps). Bearings and/or rollers between the first and second portions of the platform (34) can permit relative rotation therebetween, such that life raft (32) is able to move relative to the platform (34) in a horizontal plane, such as when affected by wind, waves, current, and/or other forces.

When evacuation of a facility is desired, the system can be deployed by lowering the chute (1), raft (32), platform (34), and stabilization members (36) to the water (30) using the winch (24), after opening the trap door (40) (e.g., by removal and/or manipulation of a retaining pin assembly or similar mechanism.) Once the raft (32) reaches the water (30), continued deployment of the stabilization members (36) beneath the water (30) can cause inflation of the raft (32) about the platform (34), such as through actuation of a shortened painter line (38) of the raft (32) attached to one of the stabilization members (36). In an embodiment, during typical use, the stabilizing members (36) (e.g., tensioning cans) can be positioned 10-15 feet below the surface of the water (30). The landing platform (34) can retain the conduit (1) in place through contact between the cables (6) and the sides of orifices within the platform (34), and optionally, through use of retaining clamps, pins, and/or other types of fasteners, while the stabilization members (36) tension the conduit (1) to maintain the conduit (1) and raft (32) in a stable position. The raft and/or platform can move freely up and down the cables (6) under the influence of wave and swell action due to the passage of the cables (6) through the orifices in the platform (34).

After the system has been deployed, personnel can enter the conduit (1) and transit directly to the raft (32). The close-knit material of the conduit (1) and/or the outer sheath (8, shown in FIG. 2) can protect personnel from fire, heat, smoke, etc. The discrete sections (4) and/or compartments of the conduit (1) and/or the arrangement of the slide panels (3) can enable each individual to move through the conduit (1) in a controlled manner (e.g., through one section at a time). Upon reaching the landing platform (34) personnel can exit the conduit (1) directly into the raft (32), thus eliminating the risks posed by exiting into a large diameter open boarding raft and then moving across the boarding raft to attempt to pull and enter a separate life raft. To accommodate for wave action, capsizing of the facility, and/or other hazards, the escape panels (10) of the conduit (1) can allow personnel to exit the conduit (1) from any section thereof For example, if wave motion moves the raft (32) upward relative to the lower end of the conduit (1), personnel could exit whichever cell of the conduit (1) is adjacent to the raft (32), independent of the physical location of the bottom of the conduit (1).

Once personnel have entered the raft (32) the raft (32) can be disconnected from the platform (34), e.g., through removal/disengagement of pins or similar fasteners connecting the platform (34) to the raft (32) and/or to intermediate connectors, such as webbing straps. An embodiment can include a locking pin or similar member that retains the pins or fasteners in position until the locking pin is removed and/or disengaged. After disengagement from the platform (34), the raft (32) can move away from the facility and any associated hazards.

In an embodiment, the landing platform (34), conduit (1), grating (42), and/or stabilization members (36) can remain in place for future retrieval and/or reuse, such as through use of the winch (24). In an embodiment, if no pneumatic air supply is available from the facility, e.g., due to shutdown in an emergency, the accumulators can be provided with sufficient capacity to recover the system without external air.

Embodiments usable within the scope of the present disclosure can thereby provide conduits and methods that protect personnel from emergent conditions, such as flames, heat, and smoke, during an evacuation process, reduce the potential for entanglement and/or injury while traversing a conduit, and that can be deployable and boardable, from the deck of a facility, and transit directly to an escape vessel.

While certain exemplary embodiments have been described in detail and shown in the accompanying drawings, it is to be understood that such embodiments are merely illustrative of and not devised without departing from the basic scope thereof, which is determined by the claims that follow.

What is claimed is:

1. A conduit for use evacuating a facility, the conduit comprising:
a first end positioned at the facility;
a second end movable between the facility and a location remote from the facility;
a body defining an interior passage, wherein the body extends between the first end and the second end;
at least one elongate member engaged with the body and the facility for moving the second end and providing stability to the body; and
at least one stabilization member engaged with said at least one elongate member for providing stability to the body.

2. The conduit of claim 1, wherein the interior passage comprises at least one angled panel positioned therein, and wherein said at least one angled panel is adapted to enable users to transit through the body while contacting said at least one angled panel.

3. The conduit of claim 2, wherein the interior passage comprises a first angled panel positioned at a first angle relative to the body and a second angled panel adjacent to the first angled panel and positioned at a second angle opposite the first angle for enabling users to transit through the body at a controllable rate.

4. The conduit of claim 1, wherein said at least one elongate member comprises an upper end engaged with the facility, a central portion engaged with the body, and a lower end engaged with said at least one stabilization member.

5. The conduit of claim 4, wherein said at least one stabilization member is remote from the second end of the body.

6. The conduit of claim 4, wherein the upper end engages a mechanism for extending the conduit, retracting the conduit, or combinations thereof.

7. The conduit of claim 6, wherein the mechanism comprises a pneumatic winch.

8. The conduit of claim 1, wherein the second end of the conduit a platform removably engaged with an escape vessel, wherein the platform comprises at least one orifice formed therein, and wherein said at least one elongate member passes through said at least one orifice to enable relative vertical movement between the platform and said at least one elongate member.

9. The conduit of claim 8, wherein the escape vessel comprises an inflatable vessel and a mechanism for inflating the inflatable vessel engaged with said at least one stabilization member for enabling deployment of said at least one stabilization member to actuate the mechanism to cause inflation of the inflatable vessel.

10. The conduit of claim 8, further comprising a skid frame, a container, or combinations thereof, engaged with the facility and adapted to contain the escape vessel, the platform, and the conduit.

11. The conduit of claim 1, wherein the conduit comprises a first opening proximate to the first end in communication with the facility and a second opening proximate to the second end in communication with the location remote from the facility for enabling direct transport of personnel from the facility to the location remote from the facility through the conduit.

12. The conduit of claim 11, wherein the conduit comprises at least one additional opening between the first opening and the second opening to enable exiting of the conduit at an intermediate position between the first end and the second end.

13. The conduit of claim 1, wherein at least a portion of the body comprises an external layer adapted to resist flame, heat, smoke, or combinations thereof.

14. The conduit of claim 1, wherein at least a portion of the body comprises a material adapted to resist flame, heat, smoke, or combinations thereof.

15. The conduit of claim 13, wherein the material comprises Kevlar.

16. The conduit of claim 1, wherein the body comprises a close-knit material adapted to reduce a potential for entanglement of a user within the interior passage.

17. The conduit of claim 1, wherein the body comprises a plurality of modular sections and at least one connecting member positioned between a first modular section and a second modular section.

18. The conduit of claim 16, wherein said at least one elongate member engages said at least one connecting member.

19. A method for enabling evacuation of a facility, the method comprising the steps of
extending an end of a conduit from the facility to a location remote from the facility, wherein the conduit comprises a body defining an interior, at least one elongate member engaged with the body and the facility, and at least one stabilization member engaged with said at least one elongate member for providing stability to the body;
providing an opening in the conduit between the facility and the interior; and
providing at least one additional opening in the conduit for enabling users to enter the opening, transit through the interior, and exit the conduit through said at least one additional opening.

20. The method of claim 1, wherein the interior comprises at least a first angled panel positioned therein at a first angle relative to the body and a second angled panel adjacent to the first angled panel and positioned at a second angle opposite the first angle, the method further comprising permitting at least one user to transit through the interior by contacting the first angled panel and transiting in a first direction, and subsequently contacting the second angled panel and transiting in a second direction for enabling users to transit through the body at a controllable rate.
